(19) United States
(12) Patent Application Publication
(10) Pub. No.: US 2003/0014749 A1
(43) Pub. Date: Jan. 16, 2003

(54) Leisure facility visitor interaction system

(75) Inventors: Paul R. Simons, Red Hill (GB); Liesbeth M. Scholten, Eindhoven (NL); Johannes A. Jansen, London (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/186,709

(22) Filed: Jul. 1, 2002

(30) Foreign Application Priority Data
Jul. 10, 2001 (GB) 0116820.2
May 14, 2002 (GB) 0210948.6

(51) Int. Cl. H04H 7/00; H04N 7/16; G06F 17/60; G06F 3/00; H04N 5/445; G06F 13/00

(52) U.S. Cl. 725/23; 725/60; 455/3.06; 705/26

(57) ABSTRACT

A leisure facility visitor interaction system is described. A plurality of transmitter/receivers (30) are distributed over the leisure facility (10). Portable terminal devices (20) are used, each portable terminal device (20) being issued to one or more visitors to the leisure facility (10), each transmitter/receiver (30) providing a transmission zone (35) and each having one or more electronic facilities or offers concerning the leisure facility (10) accessible via the respective transmission zone (35), wherein the portable terminal devices (20) are configured to communicate with the transmitter/receivers (30) when within the respective transmission zone to thereby access the facilities or offers.

The present invention relates to a leisure facility visitor interaction system including facilities for providing electronic coupon delivery and redemption within theme parks and similar environments.

Coupons, vouchers and tokens having no direct monetary value are used in a number of environments. For example, reward points are used in supermarkets. These allow the store to gain important market information about consumers, to build a relationship with their customer, offer bonuses for loyalty, track purchases and to use promotions to help the selling of various products.

More recently, electronic versions of coupons, vouchers and tokens, herein after referred to as “e-coupons” have been used.

ZagMe is one form of e-coupon system that operates by delivering SMS messages to mobile phones whilst a subscribed consumer visits a shopping centre. Users subscribe by submitting details of their sex, age and shopping preferences. They indicate when they will be visiting the centre and are awarded with Zag points every time they receive adverts embedded within the SMS messages. Additional points may be added by recommending a friend to try the service. Zag points may be used in the form of e-coupons to receive money off sales at the shopping centre.

Unlike supermarkets and shopping centres, people go to theme parks and similar environments with only one common goal. Their objective is to enjoy themselves, and to certain extent, spend money. Theme parks typically provide rides and attractions that will appeal to their customers. In most theme parks, a single entrance fee is charged and then access to all rides and attractions is not subject to a further charge. However, rides and attractions tend to occupy a huge area, limiting the overall number of possible rides and meaning that popular rides have large queues. Effort from both the theme park operators and visitors is required to ensure that visitors are able to visit the various attractions and rides without significant queuing or overcrowding. The better arranged the theme park, the more likely incoming revenue will be increased (due to, for example, increased popularity and people spending less time in queues) and the greater enjoyment likely to be had by the visitors. As visitors usually visit in groups, the grouping effect must also be addressed as park “throughput” can be further decreased.

Much of the time spent in theme parks is spent queuing as there are too many people compared to the space available on the rides. One objective of theme parks is to attempt to load balance rides thereby making less popular rides more attractive. The most attractive rides are typically spread across the park. A particular problem is that current theme parks provide little opportunity to do anything whilst in queues resulting in boredom, frustration and restless children.

Many theme parks provide paper coupons offering discounts to attractions, food and their shopping outlets. However, such coupons offer little in the way of interaction and can only be limited so as to expire at a certain time or date. They can also only be targeted to the extent to which they are selectively distributed to visitors.

According to a first aspect of the present invention, there is provided a leisure facility visitor interaction system including a plurality of transmitter/receivers distributed over the leisure facility and a number of portable terminal devices, each portable terminal device being issued to one or more visitors to the leisure facility, each transmitter/receiver providing a transmission zone and each having one or more electronic facilities or offers concerning the leisure facility accessible via the respective transmission zone, wherein the portable terminal devices are configured to communicate with the transmitter/receivers when within the respective transmission zone to thereby access the facilities or offers.

Preferably, purchases and expenditure within the leisure facility are made using a virtual currency, the terminal device being arranged to debit the user's virtual currency upon access to predetermined ones of the electronic facilities or offers.

Virtual currency may be awarded for activities including: playing/winning games, gambling, purchasing predetermined items/services, time spent in a hotel associated with the leisure facility whilst the leisure facility is open, use of a sponsored ride, a visit to a sponsored attraction, queuing for a predetermined time period, refund for operational problems in the leisure facility, special offers, being within a selected transmission zone at a selected time, fulfilling a mission/task/activity, or assisting load balancing by visiting under occupied parts of the leisure facility.

The virtual currency may include expiry parameters such as exiting a transmission zone associated with the awarded virtual currency, non-use of virtual currency within a predetermined time period, non-use of virtual currency by a predetermined time, or exiting the leisure facility.

An offer may comprise a virtual currency award for predetermined goods/services.

The terminal device may include a virtual currency transfer system arranged to communicate with a further terminal device to effect a transfer of virtual currency upon demand to the user of the further terminal device.

The system may include one or more virtual currency purchase stations, the terminal device being arranged to communicate with one of the virtual currency purchase stations to effect a transfer of virtual currency upon payment to the user of the terminal device.

A virtual currency award may be made to a user whose terminal device is detected as moving through a number of transmission zones in a predetermined order. Such an order could be set to control attraction loads and encourage users to visit less popular areas.

A transmission zone may be-directed to a queuing area, outlet, ride or attraction of the leisure facility.

The facilities and offers may include selected ones of: purchase of a preferential queue position, purchase of part or whole of an item or service, or a discount on the purchase of an item or service.

The terminal device may include facilities selected from: a telephone system, a messaging system arranged to communicate with other terminal devices, an audio-visual system arranged to access audio-visual presentations, and a computer-based gaming system arranged to offer access to competitions, gambling and/or games. Preferably, access to selected facilities of the terminal device is subject to payment of virtual currency. Access to selected facilities of the terminal device may also be dependent on the terminal device being within a predetermined transmission zone.

The present invention seeks to provide a method and system whereby customer enjoyment of an environment such as a theme park may be enhanced, whilst promoting increased spending and other beneficial results to the environment proprietor. In particular, the present invention seeks to provide, means of entertaining customers whilst queuing and offering them the ability to interact with the park and possibly spend money. The present invention also seeks to provide means by which offers and the like can be targeted to particular consumers based on their location, current activity, past purchase activity and the like.

Theme parks can gain knowledge about their customers by encouraging them to make use of the system according to the present invention that allows them to specify their preferences about rides and activities in exchange for a reward. Such a reward can be managed by an e-coupon system.

Examples of the present invention will now be described in detail by way of example only with reference to the accompanying drawings, in which:

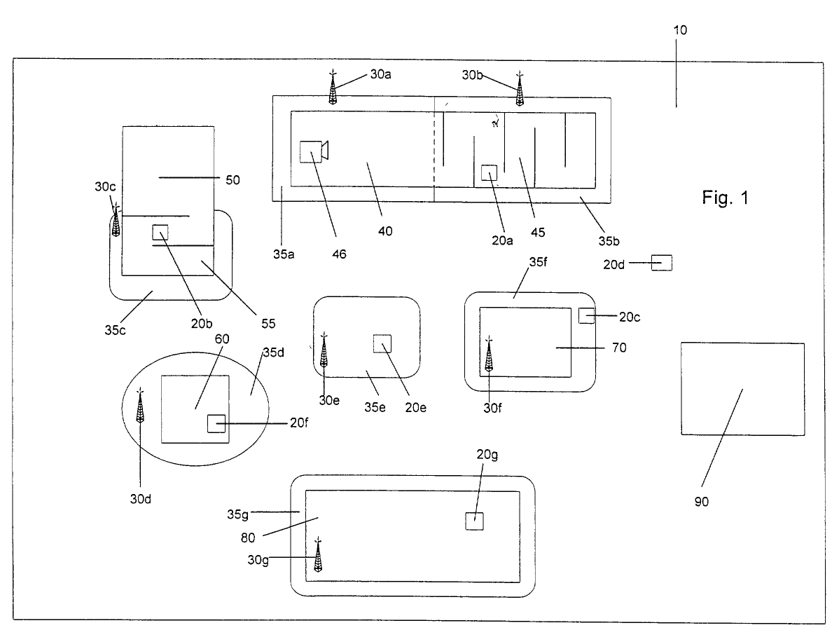

FIG. 1 is schematic diagram of the layout of a portion of a theme park;

FIGS. 2 to 5 schematically illustrate differing operational scenarios supported by the present invention; and,

FIG. 6 represents a two-way transaction supported by the present invention.

FIG. 1 is a schematic diagram of a plan of a portion of a theme park incorporating a system in accordance with the present invention.

The portion of the theme park 10 includes rides 40, 50, a retail outlet 60, a food outlet 70 and an ornamental garden attraction 80. Queuing areas 45 and 55 are provided for the rides 40 and 50 respectively. A number of wireless transmitter/receivers 30a-30g are distributed around the theme park 10. The transmitter/receivers 30a-30g communicate with a central control unit 90.

Visitors to the theme park 10 are each issued with a terminal device 20a-20g. The terminal device 20a-20g is arranged to communicate with the transmitter/receivers 30a-30g.

Users can interact with facilities within the theme park 10 via the terminal devices 20a-20g.

User carrying terminals 20a-20g that happen to be within a transmission zone 35a-35g of a transmitter/receiver 30a-30g respectively are able to receive communications from that transmitter/receiver 30a-30g and take advantage of any offers or facilities it may provide.

Taking, as an example, the user holding transmitter device 20a in queuing zone 45, games may be provided to the user via the terminal device 20a. In addition, the device may be used for gambling, booking rides at a later time or to provide other facilities.

It is preferred that the terminal devices 20a-20g operate on an e-coupon currency. E-coupons can be awarded for playing sponsored games on the Internet, spending money at the theme park 10, gambling with existing e-coupons, fulfilling a mission set by the theme park 10, playing on slot machines and winning at other amusements, queuing for a long period of time, special offers or product promotions based on proximity to a shop/sales point, a refund mechanism and, taking part in a particular activity or spectacle. E-coupons could be spent on an e-queuing system allowing users to purchase a preferential position in queues, buying any item or part purchasing items from the theme park 10, free telephone calls or other facilities from the terminal device 20a-20g, providing entry into competitions managed by the mobile device 20a-20g, or gambling on the mobile device. E-coupons may be transferable between a group of people, as illustrated in FIG. 2. They may be given a limited validity period (for example only valid for a duration of visit or only during a valid area). For example, the use of terminal device 20c may be offered discounted food for a predetermined period whilst in zone 35f if purchased from food outlet 70. Furthermore, the central control unit 90 can manage distribution of the e-coupons and dynamically control their distribution to encourage users to visit less popular attractions such as the ornamental gardens 80 or to purchase items from the outlets and food stands.

Because the terminal devices 20a-20g identify the user and their position within the park 10, audio visual capture devices such as the camera 46 may be triggered when the user is in the correct vicinity or on a particular ride and data obtained from the audio visual capture devices can then be sold to the user in return for a number of e-coupons or transmitted to their home at a later date. Terminal devices 20a-20g may also be issued to children to allow parents to track their locations.

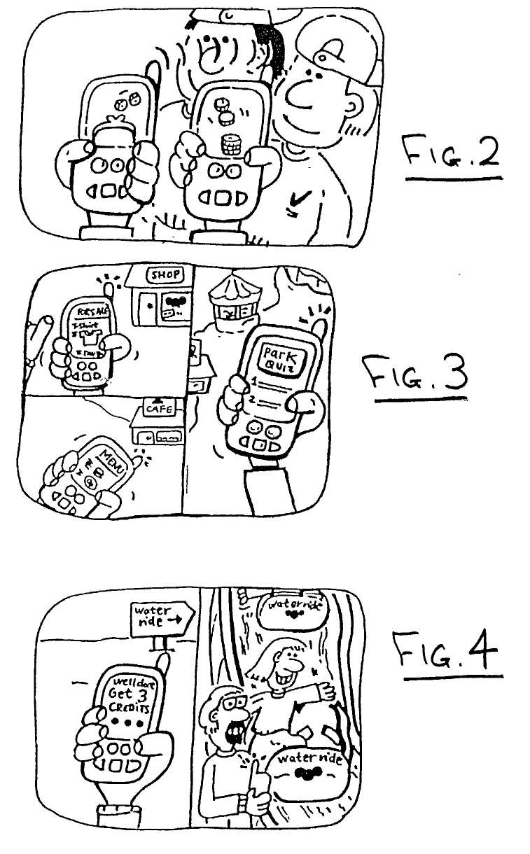

The throughput of the park can be improved by using e-coupons to stimulate visits to less busy areas (for example you get e-coupons if you visit the ornamental garden 80) or by awarding e-coupons for following certain paths through the theme park 10 (this may be presented to a user in the form a park quiz or treasure hunt) as illustrated in FIG. 3. E-coupons may also be used for load balancing, identifying a group's location and attracting them to less popular areas for an e-coupon reward, as illustrated in FIG. 4.

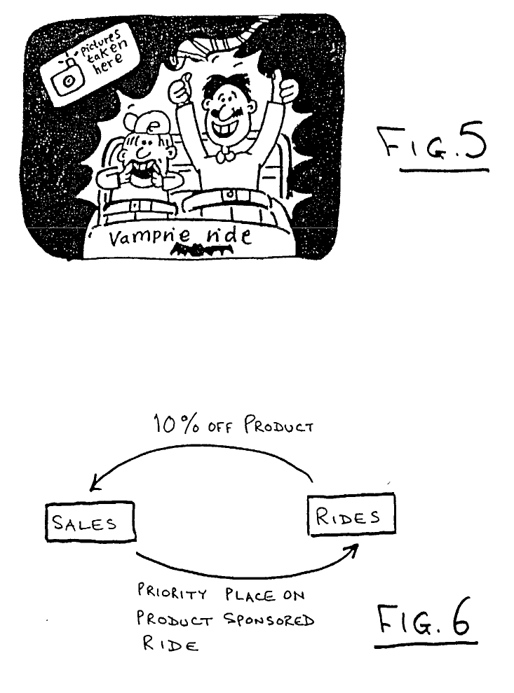

E-coupons can make it easier for people to buy souvenirs such as pictures that are taken on the rides, as illustrated in FIG. 5. The purchase can be completely “virtual” by exchange of e-coupons for a reference number or other digital code. Pictures/souvenirs can be picked up at a suitable moment (such as at the end of a visit) or digital pictures could be viewed on the terminal, with the option to buy allowing the images to be collected later or sent directly to the visitor's email address. The advantage of this mechanism is that people can order items at the touch of a button, reducing staffing levels on the ride, whilst not having to carry things with them through the theme park 10, which in turn leads to reduced congestion at exits of rides/sales points of pictures.

Rides and the like could be sponsored using a product placement, as illustrated in the diagram of FIG. 6. For instance, an electronic signal may be sent to terminal devices 20 allowing a customer to buy a soft drink at a discounted price (for example, at a 10% discount of the retail price) and get an e-coupon specifically for the manufacturer/sponsored ride. This generates revenue both for the park in sponsorship and in the increased sale of the product. Some e-coupons may be issued electronically for specific products at a specific outlet but have an expiry perimeter that validates the coupon only if the person stays within a fixed range (for example within 10 meters of an ice cream outlet). This allows the central control unit 90 to market products directly to specific consumers (such as those with a history of accepting such purchases) at advantageous times (such as when the ice cream outlet is not busy) or locations. E-coupons work well with a centralised billing system since the central server 90 may judge a product placement by using a user's profile, location and an opportunistic time (such as offering ice creams in hot weather) and by tracking all the purchases to determine the best product to offer.

Individuals can have separate terminal devices 20a-20g or they may be distributed to groups of people. By transfer of e-coupons, groups can distribute rewards and parents can give children a certain amount of e-coupons to spend in a park. This can be done directly using the same radio network used to connect the terminal devices 20a-20g to park services via transmitter/receivers 30. E-coupons may be gambled using special applications that run on the terminal devices 20a-20g. Some applications may be applicable at all times whilst others may be available only on queues for specific rides. Access to such games or reception of special offers may be restricted by requiring the handset to be within a specific range 35a-35g of a transmitter/receiver 30a-30g.

Theme park hotels can also make use of e-coupons. For example, for every minute spent within the hotel whilst the theme park is open, e-coupons could be earnt. Purchases within the hotel could be tracked via the use of the terminal device to earn e-coupons. A person may also be encouraged to take up offers to earn e-coupons for the upcoming day at the park.

To improve customer confidence in the system, spending or transferring e-coupons may occur over a secure channel between mutually authenticated terminal devices 20a-20g and transmitter/receivers 30 or devices/rides/games. In the above description we have described a promotional transaction system designed to run in theme parks and similar locations in which electronic coupons can be awarded and spent by consumers. E-coupons fit into a plan whereby a wireless network is established over a theme park and users carry mobile wireless terminal devices to improve their experience by offering location based services, help as well as the ability to acquire and spend e-coupons. The e-coupons are controlled and logged by a central control unit 90 which is connected to the terminal device 20a-20g via the transmitter/receivers 30. E-coupons could also be purchased via cash terminals (similar to ATM terminals) distributed throughout the theme park 10. Using e-coupons as a currency, they may be exchanged between people or gambled as a form of entertainment at the theme park, allowing small units, which have little value, to grow into units of higher value. Unlike currency, e-coupons typically have an expiry parameter, such as time or proximity to an attraction encouraging people to spend them whilst they are still valid.

As mentioned above, the main field of application for the present invention is for use in theme parks and the like. However, it is also applicable to holiday camps, shopping malls, ski resorts, spectator events and other social gatherings where people roam over a controlled area. As such the present invention may also be applied to hotels, museums, art galleries and the like.

Although principally described in terms of a software-based or controlled implementation, the skilled reader will be well aware that many of the above described functional features could equally well be implemented in hardware or a combination of software and hardware.

From reading the present disclosure, other modifications will be apparent to persons skilled in the art. Such modifications may involve other features which are already known in the design, manufacturing use of communication and monitoring systems and/or data network access apparatus and devices and component parts thereof and may be used instead of or in addition to features already described herein.

1. A leisure facility visitor interaction system including a plurality of transmitter/receivers distributed over the leisure facility and a number of portable terminal devices, each portable terminal device being issued to one or more visitors to the leisure facility, each transmitter/receiver providing a transmission zone and each having one or more electronic facilities or offers concerning the leisure facility accessible via the respective transmission zone, wherein the portable terminal devices are configured to communicate with the transmitter/receivers when within the respective transmission zone to thereby access the facilities or offers.

2. A system according to claim 1, wherein purchases and expenditure within the leisure facility are made using a virtual currency, the terminal device being arranged to debit the user's virtual currency upon access to predetermined ones of the electronic facilities or offers.

3. A system according to claim 2, wherein virtual currency is awarded for activities including: playing/winning games, gambling, purchasing predetermined items/services, time spent in a hotel associated with the leisure facility whilst the leisure facility is open, use of a sponsored ride, a visit to a sponsored attraction, queuing for a predetermined time period, refund for operational problems in the leisure facility, special offers, being within a selected transmission zone at a selected time, fulfilling a mission/task/activity, or assisting load balancing by visiting under occupied parts of leisure facility.

4. A system according to claim 2, wherein the virtual currency includes expiry parameters.

5. A system according to claim 4, wherein the expiry parameters include selected ones of: exiting a transmission zone associated with the awarded virtual currency, non-use of virtual currency within a predetermined time period, non-use of virtual currency by a predetermined time, exiting the leisure facility.

6. A system according to claim 2, wherein an offer comprises a virtual currency award for predetermined goods/services.

7. A system according to claim 2, wherein the terminal device includes a virtual currency transfer system arranged to communicate with a further terminal device to effect a transfer of virtual currency upon demand to the user of the further terminal device.

8. A system according to claim 2, further comprising one or more virtual currency purchase stations, the terminal device being arranged to communicate with one of the virtual currency purchase stations to effect a transfer of virtual currency upon payment to the user of the terminal device.

9. A system according to claim 2, wherein a virtual currency award is made to a user whose terminal device is detected as moving through a number of transmission zones in a predetermined order.

10. A system according to claim 1, wherein a transmission zone is directed to a queuing area, outlet, ride or attraction of the leisure facility.

11. A system according to claim 1, wherein the facilities and offers include selected ones of: purchase of a preferential queue position, purchase of part or whole of an item or service, or a discount on the purchase of an item or service.

12. A system according to claim 2, wherein the terminal device includes facilities selected from: a telephone system, a messaging system arranged to communicate with other terminal devices, an audio-visual system arranged to access audio-visual presentations, and a computer-based gaming system arranged to offer access to competitions, gambling and/or games.

13. A system according to claim 12, wherein access to selected facilities of the terminal device is subject to payment of virtual currency.

14. A system according to claim 12, wherein access to selected facilities of the terminal device is dependent on the terminal device being within a predetermined transmission zone.
